(19) United States
(12) Patent Application Publication
(10) Pub. No.: US 2009/0152366 A1
(43) Pub. Date: Jun. 18, 2009

(54) Non-quadrilateral data-encoded card apparatus

(76) Inventors: William A. Anderson, II, Cumming, GA (US); Sherri D. Anderson, Cumming, GA (US)

Correspondence Address: William A. Anderson II, P.O. Box 1408, Cumming, GA, 30028, US

(21) Appl. No.: 12/380,038

(22) Filed: Feb. 23, 2009

Related U.S. Application Data
(63) Continuation-in-part of application No. 29/286,082, filed on Apr. 23, 2007.

(51) Int. Cl. G06K 19/06; G06K 5/00

(52) U.S. Cl. 235/493; 235/380

(57) ABSTRACT

A non-quadrilateral data-encoded card is provided having a partially circular shape with a substantially straight edge portion. A data-storage region is disposed on one side of the card substantially parallel to but spaced from the straight edge portion. A case for the card is formed from first and second cover portions. The first and second cover portions are pivotally connected to each other and to the card. As a result of the pivotal connection, the card may be pivotally accessed easily relative to the first or second cover portions. The card with its uniquely shaped partially circular peripheral extent and straight edge portion has application as a credit card, debit card, gift card, or other value associated card.

### RELATED APPLICATION

The present application is a continuation-in-part of my prior co-pending application, Ser. No. 29/286,082; filed Apr. 23, 2007, which application hereby is incorporated herein by this reference.

### BACKGROUND OF THE INVENTION

1. Field of Invention

The present invention relates to data-encoded cards of non-quadrilateral shape or configuration, preferably of generally circular or partially-circular shape. Such cards have particular application as credit cards, debit cards, gift cards or other “value-associated” or “stored-value” cards, but may also be used as identification cards or data-storage cards. The encoded-data non-quadrilateral shaped card of the invention may have an associated case that is accessed in a variety of ways, such as on a lanyard, retractable lanyard or a key chain, clipped to an accessory such as a belt or clothing, or kept in a pocket or bag. The case is configured to hold, conceal or protect the non-quadrilateral shaped credit card or gift card or other value-associated card or other-purpose card, but render the card easily accessible.

2. Description of Prior Art

Cards of the type herein involved, for example credit cards or debit cards, usually are of rectangular configuration. Nonetheless, in our prior U.S. Design Pat. No. 405,116; issued Feb. 2, 1999; we disclose an identification card of unique circular shape. In Nelms et al, U.S. Pat. No. 7,290,364, there is disclosed a non-rectangular shaped credit or transaction card with an associated case. The specifications of our prior Design Pat. No. 405,116, and of the Nelms et al patent are hereby incorporated herein by this reference.

As pointed out by Nelms et al, special value cards have been provided by grocery, pet supply and other merchant stores in the form of cards with key loops or key chain attachment features. The advantage of having the card accessible outside of a wallet or purse, such as on a lanyard, retractable lanyard or a key chain, is that the user has the card available at his or her convenient deposal instead of having to open a purse or wallet. Having the card in the accessed position increases the likelihood of usage of the card, in contrast to requiring the user to remove the card from a wallet and/or purse and make a choice to use a particular card from among several possible choices.

Having the card already accessed and in a useable position outside of a wallet and/or purse is advantageous for the card supplier as it enhances the opportunities for use of the card. Accordingly, suppliers of conventional credit cards desire the advantages of having their particular card in the accessed position and outside of the wallet or purse. In the case of a conventional credit card, the user typically carries a number of such cards and has a choice among cards for use. For example, the user may often choose from one or more credit cards in multiple accounts or from a particular department store or other branded card. Thus, the supplier of the conventional credit card would obtain an advantage over other conventional credit cards by having the card in the accessed position, in contrast to the other cards being maintained in the wallet or purse.

Having a standard credit card in the accessed position, such as on a key chain in the same manner as a stored value card, presents additional problems. First, conventional credit cards are the target of theft of not only the card itself, but the card number printed on the card. Thus, having the credit card in the open, such as on the end of a key chain, presents a target for card thieves. Second, conventional credit cards are expected to have a longer life than a stored value card. Having the conventional credit card in the accessed position on a key chain would subject the card to substantial abuse and wear and tear, which will require more frequent replacement, or cause malfunctioning of aspects of the card, such as the magnetic stripe, or cause an identification photograph to be defaced or marred.

Additionally, the size and shape of a conventional credit card makes it disadvantageous to carry for special uses such as on a lanyard, retractable lanyard or key chain attachment. The rectangular shape and conventional size requires an equally large sized container or holder to cover the card. The rectangular shape also limits the options for container size and shape and access to the card within a case. Key chain containers are inherently limited in size and weight in order to promote their use. Bulky or excessively large key chain holders will pull the key when used in a car ignition, or add weight or size to an item that is typically carried in a pocket or a purse.

Standard credit card magnetic stripe readers are designed to receive a rectangular shaped card with at least one edge that is flat or substantially straight. The cards are designed with at least one edge that is straight and parallel to the direction of the encoding on the magnetic stripe. The edge of the card serves as a reference for the stripe reading heads, which are located a specified distance from the base, or the same distance from the edge of the card to the location of the magnetic stripe. Moreover, the magnetic stripe has a specified length and width in order to record a particular number of tracks of recorded data. These standards for card sizes and shapes and magnetic stripe specification provide disincentives for modification of the physical features of credit cards and the associated stripe. The present invention provides an unconventional, or non-quadrilateral, shaped credit card or gift card, and an associated case, that still allows usage with a standard magnetic stripe card reader because it provides a straight edge portion for maintaining the ability of most card readers to sense the stripe on the card. As such, the present invention incorporates the “best of both worlds” with respect to the desirable features mentioned above.

Moreover, the Nelms et al patent fails to contemplate the use of improved card security features. The card of the present invention is suited to carry a bar-code feature in addition to a magnet stripe will allows for greater functionality with electronic payment systems (i.e. card readers, point of sales systems, bar scanning equipment, etc.)

### SUMMARY OF THE INVENTION

To achieve the foregoing and other advantages and benefits, the present invention, briefly described, provides a credit card or gift card or other “value” card and associated case or holder. The card has a configuration that complements the configuration of the case so that the card is easily removed from the holder for access, yet is maintained inside the case in a covered position and is protected from abuse. The case is designed to be light-weight and easily carried.

In one or more embodiments, the card is a credit card. The card has a first end with at least one portion formed of a first radius. The card has a second end with at least one portion formed of a second radius. The second end portion of a second radius defines a substantially straight edge portion. In one or more embodiments, the shape of the card's main portion is circular or semi-circular or arcuate.

In one or more embodiments, the case for the card is formed in two portions, or first and second cover portions. Additionally, each of the first and second cover portions includes connecting portions for connection to each other and to the card. In one or more embodiments, the cover connecting portions and the card connecting portion define a pivotal connection so that the card may be pivotally accessed easily relative to the first or second cover portions.

The card is interposed between the first cover portion and the second cover portion. The card is movable between said first and second cover portions from a closed position in which the card is enclosed by the cover portions to an open position in which a majority of the lower surface area of the card is exposed from the cover portions to permit access to the card. In other words, in the closed position, the surface area of the card is enclosed within the cover portions or case portions in order to protect the card and keep the identification information on the card out of visual view. In the open position, a majority of the surface area of the card is exposed so that the card can be dragged through a card reader without having to completely detach or remove the card from the case. In one or more embodiments, the card is pivotally connected to the upper and lower cover portions. The card is detachable or removable from the pivotal connection to the upper and the lower cover portions, in order to be fully removed from the case. The upper and lower case portions and the card may be thin, elongated members formed of a plastic substrate, such as where the card is a plastic credit or gift card or other “value” card. The card may also be formed of a paper substrate, such as when the card is a telephone card or other stored value card. One or more cards may be placed within the case, depending on the structure of the case.

The above brief description sets forth rather broadly the more important features of the present invention in order that the detailed description thereof that follows may be better understood, and in order that the present contributions may be better appreciated. There are, of course, additional features that will be described in this specification and which will be for the subject matter of the claims appended hereto.

In this respect, before explaining one or more embodiments in detail, it is understood that the invention is not limited in its application to the details of the construction and to the arrangements of the components set forth in the following description or illustrated in the drawings. The invention is capable of other embodiments and of being practiced and carried out in various ways. Also it is to be understood, that the phraseology and terminology employed herein are for purpose of description and should not be regarded as limiting. Those skilled in the art will appreciate that the conception, upon which the disclosure is based, may readily be utilized as a basis for designing other structures, methods, systems, etc., for carrying out the several purposes of the present invention. It is important therefore, that the claims annexed hereto and made part hereof, be regarded as including equivalent construction insofar as they do not depart from the spirit and scope of the present invention.

It is therefore an object of the present invention to provide a new and improved non-quadrilateral card apparatus which has all the advantages of the prior art and none of the disadvantages.

An even further object of the present invention is to provide a new and improved non-quadrilateral card apparatus which may easily and efficiently be manufactured and marketed.

Still yet a further object of the present invention to provide a new and improved non-quadrilateral card apparatus which is of durable and reliable construction.

Yet still another object of the present invention is to provide a new and improved non-quadrilateral card apparatus which provides a credit card or gift card or other “value” card and associated case or holder.

Yet another object of the present invention is to provide a new and improved non-quadrilateral card apparatus which has a configuration that complements the configuration of its holder or case so that the card may be easily removed from the case for access, yet is maintained inside the case in a covered position and is protected from abuse.

Still yet another object of the present invention is to provide a new and improved non-quadrilateral card apparatus which has a first end with at least one portion formed of a first radius, a second end with at least one portion formed of a second radius, and wherein the second end portion of a second radius defines a substantially straight, flat edge portion.

Yet still yet another object of the present invention is to provide a new and improved non-quadrilateral card apparatus which has a first end with at least one portion formed of a first radius, a second end with at least one portion formed of a second radius, and wherein the second end portion of a second radius defines a substantially straight, flat edge portion, said card apparatus further having a data-encoded magnetic strip proximal to said flat edge portion.

Another object of the present invention to provide a new and improved non-quadrilateral card apparatus in which the shape of the card's main portion is circular or semi-circular or arcuate.

Still yet another object of the present invention to provide a new and improved non-quadrilateral card apparatus wherein a holder or case is provided for the card, wherein the case is formed in two portions, or first and second cover portions, wherein each of the first and second cover portions has a first end with a portion formed of a first radius and a second end with a portion formed of a second radius, and wherein the first radius and the second radius are substantially the same.

Another object of the present invention is to provide a new and improved non-quadrilateral card apparatus wherein a holder or case is provided for the card having first and second cover portions, and wherein additionally, each of the first and second cover portions include connecting portions for connection to each other and to the card.

Yet another object of the present invention is to provide a new and improved non-quadrilateral card apparatus wherein a holder or case is provided for the card having first and second cover portions, each of the first and second cover portions include connecting portions for connection to each other and to the card and in which the cover connecting portions and the card connecting portion define a pivotal connection so that the card may be pivotally accessed easily relative to the first or second cover portions.

These together with still other objects and advantages of the invention, along with the various features of novelty which characterize the invention, are pointed out with particularity in the claims annexed to and forming part of the instant disclosure. For a better understanding of the invention, its operating advantages and the specific objects attained by its uses, reference should now be had to the accompanying drawings and descriptive matter in which there is illustrated one or more preferred embodiments of the invention.

### BRIEF DESCRIPTION OF THE DRAWINGS

The present invention will be better understood and the above objects as well as objects other than those set forth above will become more apparent after a study of the following detailed description thereof. Such description makes reference to the annexed drawings wherein:

FIG. 1 is a schematic depiction in perspective of the encoded-data card apparatus of the invention in use and being swiped through a card reader in order for encoded information on the card to be processed externally by transactional equipment (not shown).

FIG. 2 is a view in elevation of a first side of the encoded-data card apparatus shown in FIG. 1.

FIG. 3 is a view in elevation of a second side of the encoded-data card apparatus shown in FIG. 1.

FIG. 4 is a view in elevation of the holder or case for the encoded-data card apparatus of FIG. 1.

FIG. 5 is a cross-sectional view taken along line 5-5 in FIG. 4.

FIG. 6 is a schematic depiction in perspective of an individual wearing the encoded-data card apparatus and case around the neck thereof via a lanyard and accessing the card apparatus so as to enable it to be swiped through a card reader.

### DETAILED DESCRIPTION OF THE PREFERRED EMBODIMENTS

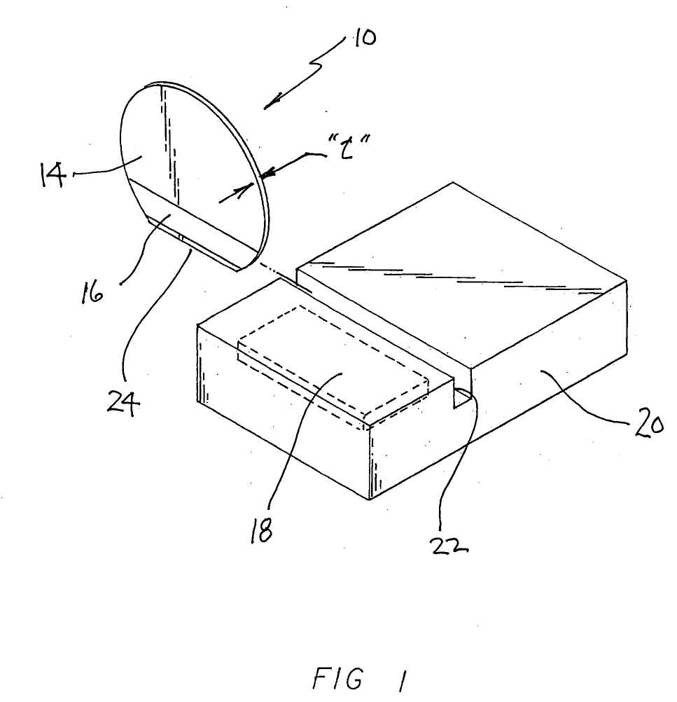

Turning initially to FIGS. 1-3, one preferred embodiment of the invention is depicted comprising a credit card 10 characterized by a first side 12 which may be a front side bearing identifying indicia, a logo, graphical designs or the like, and a second or back side 14 bearing a magnetic stripe 16. The magnetic stripe is indicated in FIG. 3 by cross-hatched lines which represent the color “black.” The magnetic stripe 16 extends transversely across the second or back side from one side edge to the opposed side edge substantially as depicted in FIG. 3.

The card has a substantially uniform thickness indicated by the dimension “t,” which thickness is defined by the distance between first side 12 and second side 14. As is well known in the art, data or other information may be encoded on stripe 16 (and therefore card 10) and all or portions or selected “bits” of the encoded information may be read by the sensing head 18 of a card reader 20 (FIG. 1) when the card and the stripe 16 are passed through a suitable slot 22 in reader 20 (i.e. swiped) in order that electrical signals may be sent form the reader to external data processing equipment (not shown). It will be appreciated that alternatively, credit card 10 may be a debit card, a gift card, a stored-value card or any other card having “value” associated therewith. The term “value” or “value-associated” card as used herein therefore should be construed in its broadest sense and may even encompass a card bearing non-financial information such as, for example, medical or identifying information.

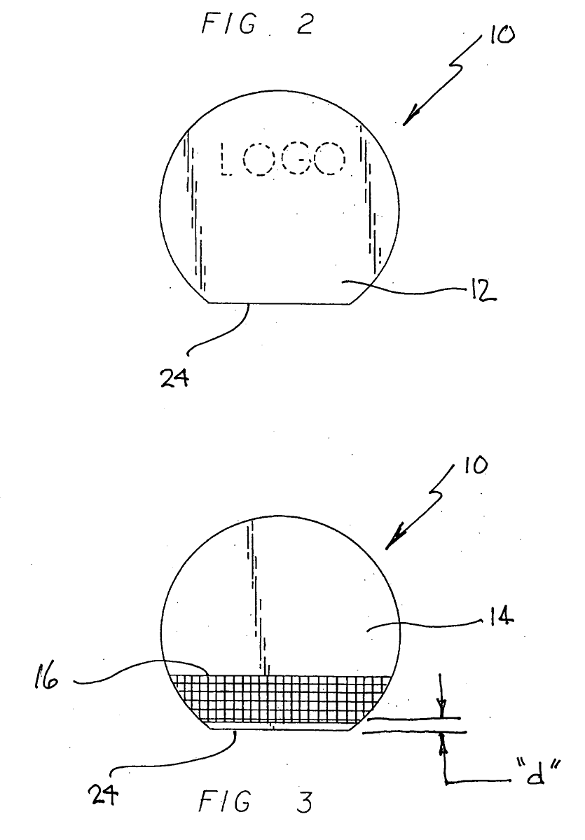

An important feature of the present invention is the unique configuration of card 10. As best seen in FIGS. 2 and 3, the card 10 has a generally circular peripheral shape exclusive of a bottom substantially straight edge portion 24. Straight edge portion 24 defines a flat surface which functions as a reference for location of magnetic stripe 16 which lies above the bottom flat surface defined by edge portion 24 by a distance “d” and is oriented substantially parallel thereto. By this arrangement, a generally circular or partially-circular (arcuate) card 10 can be swiped through slot 22 in a card reader 20 and magnetic stripe 16 will accurately align with the sensing head in the reader as the card's flat bottom surface defined by edge portion 24 contacts and travels along the bottom surface or floor of slot 22. Thus, it will be appreciated that the preferred credit card 10 has a first constant radius (measured from its center) defining the substantially circular or partially-circular edge portion of the card, and a second albeit “variable” radius (measured from the same center) defining straight edge portion 24.

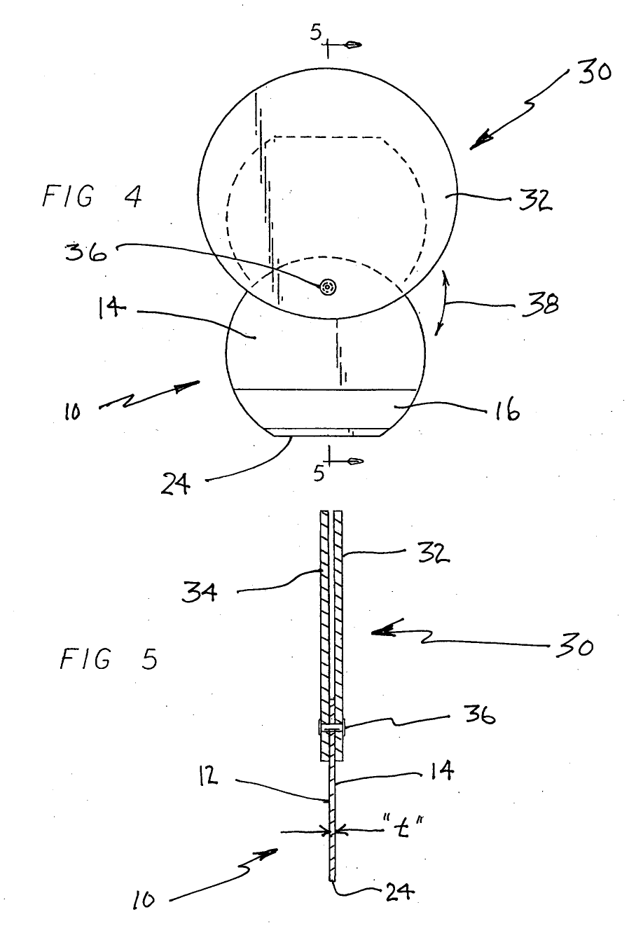

In the alternative preferred embodiment of the invention shown in FIGS. 4 and 5, a protective case or cover assembly generally designated by reference sign 30 is provided for credit card 10. Substantially as depicted therein, the cover assembly 30 comprise a first circular-shaped cover member 32 and a similarly shaped and sized second cover member 34 pivotally attached to each other and to the credit card 10 therebetween. Cover members 32 and 34 are at least as large as credit card 10, and preferably larger, in order to completely deny access to the credit card as will be made more apparent below.

The preferred pivotal attachment mechanism comprises a hollow rivet or grommet 36 suitably fastened in place through commonly axially aligned holes (not referenced) extending through the first cover member 32, the second cover member 34, and the card 10 (FIG. 5). As indicated by arrow 38 in FIG. 4, credit card 10 may be moved from a first position (indicated by broken lines) where access to the card is denied because it reposes entirely between the first and second cover members, to a second position pivotally displaced away from the first and second cover members where access to the credit card is facilitated. Preferably, the hollow rivet or grommet 36 is comprised of first and second parts suitably screw-threaded together so as to be easily assembled and disassembled. Such devices are well known and will permit removal and insertion of different credit cards 10 in cover assembly 30 as desired from time to time and as will occur to those of obvious skill.

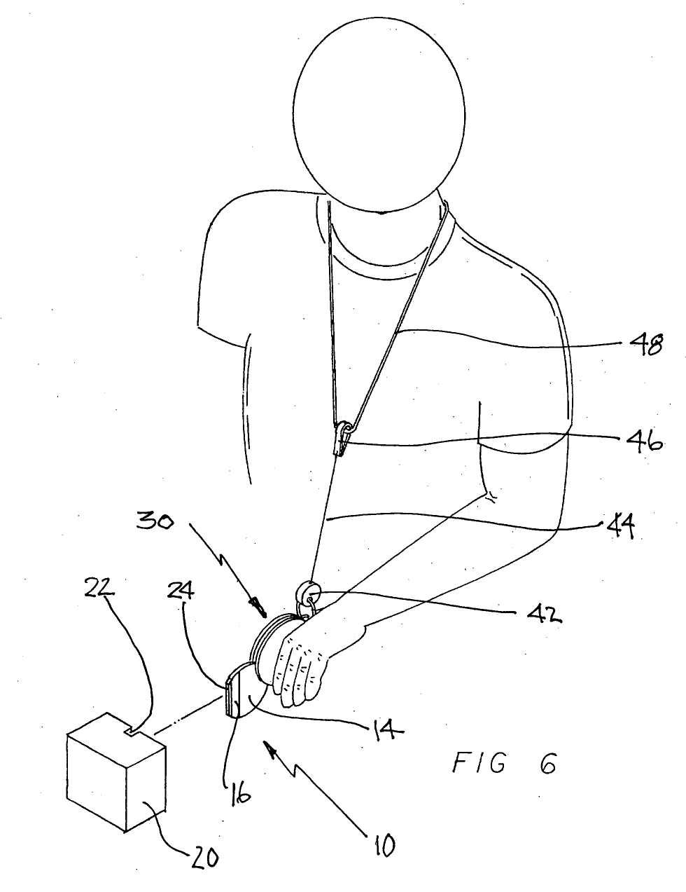

Turning to FIG. 6, there is shown another alternative embodiment of the invention where the credit card 10 and cover assembly 30 are shown being used by an individual. In this embodiment a ring 40 is provided extending through hollow rivet or grommet 36 and is suitably attached to a conventional retractable cord assembly comprising a spring-loaded reel housing 42, an extendable cord 44, and a clasp 46 which, in turn, is suitably attached to a neck lanyard 48. By this arrangement, the cover assembly 30 and its credit card 10 may be worn about the neck of the individual with the credit card normally hidden from access (broken line position FIG. 4). When it is desired to swipe the credit card 10 through the reading slot of a card reader, the credit card 10 merely is rotated into an access position (FIG. 4) and employed in the manner substantially as schematically illustrated in FIG. 6.

It will be understood, of course, that the cover assembly covers 32, 34 may be fabricated of any suitable material such as plastic, wood, paper, metal, leather, or the like and may be embellished with indicia, graphical designs or other indicia as desired. As mentioned above, the covers are circular shaped and preferably sized sufficiently large to completely conceal the credit card therein when the credit card reposes between the cover members as shown by broken lines, for example, in FIG. 4. It will also be appreciated that in lieu of the preferred retractable cord and lanyard assembly of FIG. 6, the cover assembly 30 may also be used alternatively on a key chain, fob, belt-clip or other suitable external attachment device, or may be used alone without any external attachment in the manner of a pocket case, wallet, purse or the like.

From the foregoing, it is now believed apparent that the present invention provides a non-quadrilateral, and preferably a circular or partially-circular shaped credit card or other data-encoded card with an associated case or holder. The card is formed of a configuration that complements the configuration of the case so that the card is easily removed from the holder for access, yet is maintained inside the case in a covered position and is protected from abuse. The case is designed to be light-weight and easily carried, which is an important feature in order to attach the cover to a variety of items, such as a key chain. The case is preferably configured in a circular shape so that the card may easily be rotated into and out of the holder. The case may also be of a sufficient size to include other small items, such as a microprocessor or chip.

The card and case that includes a card according to the present invention is especially suited for use with an electronic payment mechanism. The term “electronic payment mechanism” is intended to include conventional credit card readers and magnetic stripe readers, in addition to any other type of mechanism that can be used with a card to transfer payment information. Other types of mechanisms can include, without limitation, barcode scanners and readers, phone card readers, debit card readers, bank ATM card readers, or personal computers or hand-held devices that can be used in conjunction with such cards to make payments electronically by inputting card identification information, alone or in conjunction with other identification means.

As disclosed, the card of the invention may be a credit card, debit card, gift card or other “value-associated” card including cards that merely contain encoded information. The card's opposed sides define first and second surfaces, each of which, in turn, defines a surface area on oppositely oriented front and back faces of the card, respectively. Typically, card holder information, such as card number, card holder name, card expiration date, issuer name, issuer logo, or the like, are included on the surface area of the front face. Typically, the back face surface area of the card includes the magnetic stripe which has tracks of magnetically coded information relating to the card holder and the issuer. As disclosed herein, the information on the stripe may be typically accessed by dragging (swiping) the card through an associated magnetic stripe reader that has heads for reading the stripe. Associated magnetic stripe reader is meant to include, without limitation, all types of magnetic stripe reading mechanisms, such as those typically found at retail establishments.

It will be appreciated that in one or more embodiments of the invention, the front face or back face surface of the card may additionally include a bar code which has encoded information relating to stored values on the card such as dollar/cents amount on the card, the location of the store where the card is purchased, and so on. The magnetic stripe on the surface of the card electronically logs the amount paid to purchase the gift card, and any amount the recipient spends whenever he or she chooses.

While such terms as edge portion, first side and second side are used herein, the invention is to be broadly construed to include placement of various features on upper or lower or first or second ends or sides without restriction to the particular embodiments described herein. Also, the terms circular and round are intended to describe the outward or inward curve or arc of the segment.

With respect to the cover assembly, either cover member may also include a microprocessor chip embedded therein. The microprocessor chip communicates with an associated electronic payment mechanism by a radio signal transmitted there between. A radio-frequency identification (RFID) system, such as those used at gasoline and retail systems with a hand-held wand or “fob,” is contemplated for use with this chip. In one embodiment, the radio signal causes communication with an associated electronic payment mechanism and identification of information associated with the particular credit card used with the cover assembly. The electronic payment mechanism causes transmission of information relating to information contained on the card.

The cover members and the card may be thin, elongated members formed of a plastic substrate, such as where the card is a plastic credit card or gift card, for example. The card may also be formed of a paper substrate, such as when the card is a telephone card or other stored value card, or of other suitable materials. As mentioned above, cards may be removed or added to the case, and one or more cards may be placed within the case if desired.

The card may be formed by using the same fabrication techniques used for standard configured (rectangular) cards. Such conventional cards are formed by combining a series of substrates, or layers, with a series of one or more coating or clear plastic overlays. One common form of credit card is formed by utilizing a core stock of material such as polyvinyl chloride acetate (PVCA) having opaque agents and plasticizers mixed in the polymer matrix.

The core stock is the layer on which the words and symbols are printed, and numbers are embossed. A surface laminate of polyvinyl chloride or PVCA is used to provide a surface finish. The magnetic stripe is applied to the laminate under a hot stamping process that uses heat and pressure.

The cards are then punched out from a sheet or strip. The present invention contemplates punching the non-quadrilateral shaped cards from the sheet or strip, or punching the non-quadrilateral shaped cards from conventionally shaped rectangular cards in a second punching operation. The non-quadrilateral shape will allow reductions in the amount of materials used for each of the individual cards based on the smaller size of the card. Also, the fonts on the front surface of the card, and the magnetic stripe on the back surface of the card, are in a condensed format for the smaller sized, for non-quadrilateral shaped cards. The cards can be formed in any circular or semi circular size, include credit card or gift card size, or a smaller size, such as approximately two-thirds of the size of a conventional quadrilateral size.

Either of the cover members of the case assembly may include a coarse material or embossment on at least a portion of its surface to create a frictional resistance to assist pivotal movement of the case cover members with respect to the card. The coarse material may be ridges formed on the surface. If desired, the card itself may include a recessed portion, such as a fingernail slot or hole punch, on its front surface to assist pivotal movement of the card with respect to the cover assembly cover members.

With respect to the magnetic stripe on the back surface of the card, the magnetic stripe information is formed on tracks on the stripe between the opposed longitudinal ends thereof. The magnetic stripe of the present invention may use an ISO standard magnetic stripe that has non-ISO standard data, or compressed data, or may use ISO standard data. The compression of data on the stripe is necessary as a result of the stripe length on the non-quadrilateral card being less than the length of a conventional magnetic stripe on a conventional rectangular card. However, the non-ISO standard data, or compressed data, can be read in a standard magnetic stripe reading machine.

Finally, it will be understood that the card of the present invention may include various card security features such as sensor pad security. The sensor pad security card feature will interface with existing point-sale equipment, credit card readers, bar code scanners, bar code readers, optical scanners and magnetic stripe readers, electronic funds transfer networks and authorization/verification systems and similar financial transaction networks to detect counterfeit or altered credit, gift, or other “value-associated” cards. For example, when the card is swiped through the card reader, the card reader would then interface with sensor pad detection technology on said card to validate if said card has been altered. If the card reader indicates an alteration with said card, the card reader would not authenticate the card with an approval code. Similar security features such as solar security card technology, color sensitive security card technology, or micro magnetic dot security card technology may alternatively be used.

Thus, while the present invention has been shown in the drawings and fully described above with particularity and detail in connection with what is presently deemed to be the most practical and preferred embodiments of the invention, it will be apparent to those of ordinary skill in the art that many modifications thereof may be made without departing from the principles and concepts set forth herein, including, but not limited to variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification of this application.

What is claimed is:

1. Non-quadrilateral shaped encoded data card apparatus, comprising:
a card,
said card having a predetermined thickness,
said card further having a first side, and a second opposed side coextensive therewith,
said card having a first peripheral extent portion of partially circular shape and a second peripheral extent portion, said second peripheral extent portion defining a substantially flat edge portion on said card whereby said card peripheral extent is partially circular shaped exclusive of said flat edge portion,
said card further having an encoded data storage region on said first side, said encoded data storage region extending longitudinally on said first side of said card,
said data storage region being in the form of a stripe on said first side of said card, said stripe being spaced from and substantially parallel to said flat edge portion of said card throughout the longitudinal extent of said stripe.

2. The apparatus of claim 1 wherein said card is a value associated card issued to an entity, and said stripe contains encoded data relating to said entity.

3. The apparatus of claim 2 wherein said value-associated card is selected from the group containing credit cards, debit cards, gift cards or stored value cards.

4. The apparatus of claim 3 further comprising a case having first and second cover portions, each of said first and second cover portions being substantially circular shaped,
said card being interposed between said first and said second cover portions, said card being movable between said first and second cover portions from a closed position in which said first and second sides of said card are enclosed by said cover portions to an open position in which said stripe and said flat peripheral edge portion are exposed from said cover portions to permit access to said card.

5. The card and case of claim 4, wherein said card is pivotally connected to said upper and said lower cover portions.

6. The card and case of claim 2 wherein said pivotal connection is formed by a pivot pin connecting said upper and lower portions.

7. The card and case of claim 6 wherein said pivotal connection is formed by a generally cylindrically shaped rivet.

8. The card and case of claim 6 wherein said pin has an aperture opening therein to permit passage with a retractable lanyard and or a key chain loop.

9. The card of claim 3 wherein said first side of said card includes a magnetic stripe that contains information relating to said card.

10. The card of claim 9 wherein said magnetic stripe is adapted to communicate with an associated electronic payment mechanism through a card reader or hand scanner device.

11. The card of claim 10 wherein said card reader causes communication with said associated electronic payment mechanism and identification of information associated with said card, said electronic payment mechanism causing transmission of information relating to information contained on said card.

12. The card of claim 1 wherein said card has a center common to said first and second sides, and said first peripheral extent portion of partially circular shape has a first constant radius from said center, and said substantially flat edge portion has a second variable radius from said center.

13. The card of claim 1 further including a color sensitive security card technology feature.

14. The card of claim 1 further including a micro magnetic dot security card technology feature.

15. The card of claim 1 further including a solar security card technology feature.

16. The card of claim 1 further including a sensor pad security card technology feature.
